(19) United States
(12) Patent Application Publication
(10) Pub. No.: US 2003/0096143 A1
(43) Pub. Date: May 22, 2003

(54) Surface modification of talc to improve wettability and increased affinity to cellulosic fibers

(75) Inventors: Vicente Lasmarias, Highlands Ranch, CO (US); Shripal Sharma, Highlands Ranch, CO (US); Alexis Layne, Littleton, CO (US); Edward McCarthy, Lonetree, CO (US)

Correspondence Address: SHERIDAN ROSS PC, 1560 BROADWAY, SUITE 1200, DENVER, CO, 80202

(73) Assignee: Luzenac America, Inc., Englewood, CO

(21) Appl. No.: 10/236,656

(22) Filed: Sep. 5, 2002

Related U.S. Application Data
(60) Provisional application No. 60/327,638, filed on Oct. 5, 2001.

(51) Int. Cl. B05D 7/00

(52) U.S. Cl. 428/702; 427/212

(57) ABSTRACT

The present invention discloses a method of treating talc particles that will improve talc's wettability and/or talc's affinity to cellulosic fibers. The method also includes changing the charge of the talc particles from slightly anionic to cationic. The present invention, while modifying certain of talc's characteristics, also preserves talc's suitability as a pitch or stickie control in the paper making process. The process of the present invention includes the steps of coating the surface of talc particles with a metal hydroxide and then coating the surface of the talc particles with a cationic polymer.

### CROSS REFERENCE TO RELATED APPLICATIONS

This application claims priority from U.S. Provisional Patent Application No. 60/327,638 filed on Oct. 5, 2001. The entire disclosure of the provisional application is considered to be part of the disclosure of the accompanying application and is hereby incorporated by reference.

### FIELD OF THE INVENTION

This application relates generally to a process of modifying the surface of talc particles to improve wettability and to increase the talc's affinity to cellulosic fibers.

### BACKGROUND OF THE INVENTION

Talc is used in the paper making process as a filling agent or as part of a pigment mix in coated paper manufacture. In its natural form, talc is platy and hydrophobic due to its physico-chemical structure, making the use of talc in a water-based slurry difficult. The surface of the mineral has no chemical charge, although the edges of the mineral are slightly anionic. These properties are responsible for talc's suitability as a pitch or stickie control in paper but are also responsible for talc's hydrophobic tendencies.

In the paper-making process, cellulosic fibers are softened with water before being processed into paper. Fillers such as clay, titanium dioxide, talc, and calcium carbonate, are added to the papermaking process to improve paper properties such as opacity, brightness, and printability. Each filler is unique due to differences in physico-chemical and morphological properties. For example, titanium dioxide is an excellent filler for opacity purposes due to is high refractive index and particle size. Due to its hydrophobicity, talc is an excellent pitch/stickie control. In addition, talc is an excellent filler for purposes of improving machine drainage, sheet smoothness and printability. However, as a filler, talc does not affiliate with the water-based cellulosic fibers as well as certain other fillers that are more hydrophilic. If talc is to be used in the paper making process, the talc must be sheared through force in order to allow the talc to be mixed in the slurry or additional chemicals, such as surfactants, must be used in the process, adding to the cost of the raw materials. Talc's surface can be modified using surfactants or with some metallic hydroxides. The surfactants' hydrophobic part is attracted to the surface of the talc, leaving the hydrophilic part of the surfactants exposed to the aqueous medium. However, metallic hydroxide, precipitated on the surface of the talc, renders the surface of the talc less hydrophobic. Either of the aforementioned two methods of talc treatment enhances the wettability of talc. Thus, a method of treating talc particles to improve talc's wettability or hydrophilic tendencies is needed.

### SUMMARY OF THE INVENTION

The present invention discloses a method of treating talc particles to improve talc's wettability. The method can also include changing the charge of the talc particles from slightly anionic to cationic. The present invention, while improving certain of talc's characteristics for use in paper making processes, also preserves talc's suitability as a pitch or stickie control in the paper making process by maintaining some hydrophobicity of the talc. This is accomplished by creating a balance on the surface of the talc between hydrophobicity and hydrophilicity. The present invention controls the amount of treatment the talc will receive in order to leave some hydrophobic sites on the talc surface to accomplish the pitch and/or stickie control for which talc is normally used.

The process of the present invention more particularly includes the steps of coating the surface of talc particles with a metal hydroxide and optionally coating the surface of the talc particles having a metal hydroxide coating with a cationic polymer. In a preferred embodiment of the present invention, the metal hydroxide is aluminum hydroxide which can be precipitated from hydrated aluminum sulfate, commonly referred to as alum, onto the surface of the talc particles.

In yet another embodiment of the present invention, after the metal hydroxide is precipitated onto the surface of the talc, a cationic polymer is added to change the charge of the talc particle. Any cationic polymer can be used. In a preferred embodiment, the cationic polymer is selected from the group consisting of polydadmacs, polyamines, polyethyleneimines and cationic starch. The resultant talc particles are hydrophilic yet retain their excellent pitch/stickie control properties. These and other objects, features, and advantages of the invention will become apparent from the following best mode description, the drawings and the claims.

### BRIEF DESCRIPTION OF THE DRAWINGS

The figure which follows depicts a preferred embodiment of the invention. The invention is not limited to the embodiment depicted herein since even further various alternative embodiments will be readily apparent to those skilled in the art.

FIG. 1 depicts a flowchart of one embodiment of the present invention.

### DETAILED DESCRIPTION

At the outset, it should be understood that this invention comprises a method of modifying the surface of talc particles, the resultant modified talc particle and products made with the resultant talc particle. The description which follows describes a preferred embodiment of the invention, and various alternative embodiments. It should be readily apparent to those skilled in the art, however, that various other alternative embodiments may be accomplished without departing from the spirit or scope of the invention.

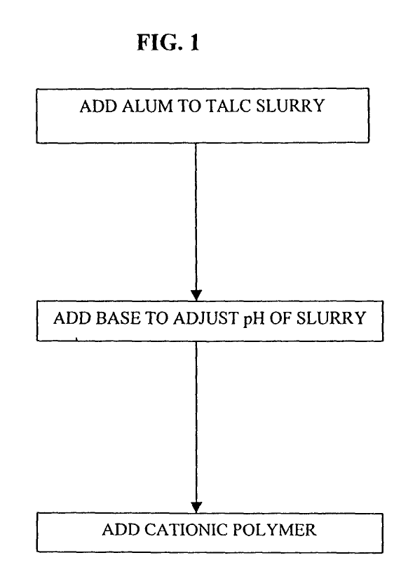

FIG. 1 shows one of the preferred embodiments of the present invention, where the surface charge of the talc is reversed. For wettability purposes, the step of adding the cationic polymer can be eliminated However, for wettability and enhanced cellulosic affinity of talc, cationic polymer is added. Reversing the charge on the edge of talc particles from anionic to cationic enhances the attraction between the anionic cellulosic fibers and the cationic talc.

In the present invention, talc particles are coated with a metal hydroxide. The metal hydroxide can be aluminum hydroxide, chromium hydroxide, magnesium hydroxide, ferric hydroxide, or manganese hydroxide. Preferably, the metal hydroxide is aluminum hydroxide.

In a preferred embodiment, the step of coating takes place in a slurry of talc. The slurry of talc is a mixture of talc and water. Preferably, the talc slurry contains at least about 5 weight percent talc solids and more preferably about 20 percent talc solids. In a more preferred embodiment, the aluminum hydroxide is formed by precipitation of aluminum hydroxide from an aluminum sulfate solution onto the surface of the talc particles in the slurry. For example, an aluminum sulfate solution is introduced into an aqueous talc slurry. The pH of the slurry of the talc particles in the metal sulfate solution is acidic, usually between 4.0 and 5.5. By raising the pH of the solution above 6.0 and preferably between 6.0 and 8.0, aluminum hydroxide precipitates from the solution and coats the talc particles. In a preferred embodiment of the invention, the pH of the solution is altered from acidic to basic by the addition of a base to the solution. In a more preferred embodiment, the base to be added is potassium hydroxide. In a preferred embodiment, the pH of the solution, once the base is added, should be above 8.0. In a more preferred embodiment, the pH should be altered to be above about 9.0 The thickness of the coating of metal hydroxide on the surface of the talc can vary, but preferably is greater than 0.00001 inches. The precipitation is controlled by monitoring the charge on the surface of the talc. Once the charge on the surface of the talc is sufficiently altered, the precipitation is stopped.

Once the pH of the slurry is adjusted to coat the talc particles with a metal hydroxide, the talc particles can be filtered and dried or can be left in the slurry for further treatment. The wettability of the talc particles is improved at this point. If the surface charge of the talc particles is to be changed to further improve these properties, the cationic polymer is then added to the slurry. The talc particles can be filtered and dried or can remain in a slurry form.

Alum is a commonly-used chemical in the paper industry. It is typically used as a sizing agent to precipitate rosin size onto cellulosic fibers and as a coagulant to neutralize anionic trash or stickies. The use of alum thereby minimizes the effect of anionic trash on the papermaking process. However, excess alum, in the presence of water, precipitates aluminum hydroxide with a change in the pH, which deposits onto pipes, distributor lines and other process equipment. Such deposits, of course, foul the system and need to be removed. Such removal is difficult to accomplish.

The use of alum as a treatment of the talc particles accomplishes two goals. First, the use of alum modifies the talc particles, making the talc even better suited for use in the papermaking process. Second, any excess alum is available to neutralize the anionic trash.

In a further embodiment of the present invention, metal hydroxide coated talc particles with a cationic polymer. The cationic polymer can be any suitable cationic polymer and, in particular, can be either cationic starch, polydadmacs, polyethyleneimines, and polyamines. In a preferred embodiment, the cationic polymer is the product Alcofix® 131, from Ciba-Geigy. The cationic polymer can be introduced to coat the talc particles in any conventional manner. For example, a polymer solution can be mixed with a slurry of metal hydroxide coated talc and the polymer molecules will interact with the coat on the talc particles, thereby introducing cationic charge groups to the talc. The amount of cationic polymer added can be adjusted based on the resulting charge of the talc in order to create an optimal balance between anionicity, which corresponds to talc's natural hydrophobic tendencies, and cationicity, which corresponds to the newly created hydrophilic tendencies. One should bear in mind that a balance between the cationic sites on the surface of the talc and the anionic sites on the surface of the talc is desirable in order to attain a balance in the talc's natural hydrophobic tendencies and the created hydrophilic tendencies. The charge of the talc particle can be determined by calculating the difference between the charge of the total slurry and the charge of a filtrate, obtained by filtering the talc slurry.

As referenced in Example 3, addition of a cationic polymer can significantly increase the wettability of the talc, as measured by the increase in precipitate in an Imhoff cone. For example, treating talc with a cationic polymer can increase the precipitate volume at the bottom of an Imhoff cone under conditions shown in Example 3, by a factor of at least about 5, more preferably by a factor of at least about 10, even more preferably, by a factor of at least about 100.

As noted above, the present invention also increases the tensile strength and porosity of paper made with the treated talc. This effect results from the increased affinity of the talc to the cellulosic fibers in the paper. As shown in Example 4, an increase in the tensile strength of the paper can be achieved. The tensile strength of paper made with the treated talc can be increased by at least about 2 BLM, more preferably at least about 5 BLM, even more preferably, at least about 10 BLM, as compared to paper made with untreated talc. Also as shown in Example 4, an increase in the porosity of the paper can be achieved. The porosity of paper made with the treated talc can be increased by at least about 5 sec/100 cc air, more preferably at least about 10 sec/100 cc air, even more preferably, at least about 15 sec/100 cc air, as compared to paper made with untreated talc.

### EXAMPLE 1

In these experiments, the chemicals used in the Examples are shown in Table 1.

TABLE 1
Chemicals Used in Examples

| Chemical | Source |
|---|---|
| Hydrated Aluminum Sulfate | AR grade as hydrated aluminum sulfate |
| (Alum) | from EM Industries, Inc. Al₂(SO₄)₃ |
| | (14-18) H₂O |
| Cationic Polymer | Alcofix ® 131 from Ciba-Geigy |
| KOH, diluted to 1% | 8N-Flach chemical |
| Talc Particles, slurried to 20% | 5 micron size, Luzenac America |
| solids | |

In this first example, the talc particles were slurried to 20% solids and then alum was added to the slurry. The pH was adjusted to between 6 and 8 pH by adding potassium hydroxide. The resultant talc slurry was separated into two samples. Sample 1 was further treated with the cationic polymer and then oven dried. Sample 2 was oven dried. A Mutek particle charge detector (“PCD”) was used to determine the talc particle charge after drying. The results were as follows:

TABLE 2
Modified Talc Particle Charge

| Sample | Particle Charge |
|---|---|
| Sample 1, Oven Dried | ++++ |
| Sample 2, Oven Dried | −10 (μeq/L) |

As Table 2 demonstrates, the particle charge of the talc was reversed by treatment of a metal hydroxide coated talc with a cationic polymer.

### EXAMPLE 2

In this experiment, three talc slurries were prepared, all at 20% solids. The first talc slurry, Slurry A, was treated with alum and with a cationic polymer; however, no base was added to the solution. The second talc slurry, Slurry B, was treated only with the cationic polymer. The third talc slurry, Slurry C, was treated with alum, a base, and the cationic polymer.

The talc slurries were prepared by adding 0.25% alum or 0.025 grams of alum to forty (40) milliliters of distilled water, for Slurries A and C, and stirred with a magnetic stirrer. To this solution, ten (10) grams of dry talc powder was added. For Slurry B, ten (10) grams of dry talc powder was added directly to the forty (40) milliliters of distilled water. The solution was stirred with a magnetic stirrer. To Slurry C, the pH was adjusted to approximately 8 by adding potassium hydroxide to the solution. The cationic polymer, Alcofix®, was then added to Slurries A and C. The quantity of the cationic polymer was calculated on a ratio basis, 0.3 mL of 1% cationic polymer to 3.6 dry grams of talc powder. This amount of cationic polymer has been found to reverse the talc charge from anionic to cationic, although other amounts of cationic polymer will also reverse the talc charge. Thus, with 10 grams of talc powder added, 0.83 mL of cationic polymer was added to Slurries A and C.

The pH and the Mutek PCD charges were determined for each of the slurries. The talc slurries were then filtered using a Buchner funnel and a Whatman No. 41 ashless filter pad. The charge of the three filtrates were then measured. The filtrate charge was subtracted from the solution charge to determine the charge of the talc particles. The pads with the talc particles thereon were then dried in an oven. The talc particles were then reslurried to 20% solids using distilled water. The pH and Mutek PCD charges were then measured. The wettability of the talc particles was evaluated visually. The results of this experiment are as follows:

TABLE 3
Wettability, pH and Mutek PCD Charges

| | | | | | | | After drying | |
|---|---|---|---|---|---|---|---|---|
| | | After | After | After Cation Polymer | | | and | |
| Slurry | | Alum | KOH | Total | Filtrate | Solids | Reslurrying | Wettability |
| A | pH | 3 8 | No | 7.4 | | | 6.9 | Better than B |
| | PCD | | KOH | 275 | 15 | 260 | 60 | |
| B | pH | No | No | 9.0 | | | 8.8 | |
| | | Alum | KOH | | | | | |
| | PCD | Added | | 250 | −20 | 230 | Neutral (0) | |
| C | pH | 3.8 | 11.5 | 11.2 | | | 9.5 | Significantly |
| | PCD | | | −280 | −10 | −270 | −44 | Better than |
| | | | | | | | | A |

Table 3 demonstrates that the treatment with alum and cationic polymer significantly improves wettability of the talc particles. In addition, Table 3 also demonstrates the talc's charge following treatment of the talc particles with the alum and the cationic polymer.

### EXAMPLE 3

Another experiment was conducted to evaluate, quantitatively, the wettability of untreated and treated talc particles using an Imhoff cone. The procedure for making the slurries was similar to that used in Example 2. 120 grams of dry talc powder was prepared into a 20% slurry. The pH of the slurry was originally 8.1 with a Mutek charge of −185 eq/L. This slurry was then split into four parts corresponding to Slurries D through G. Slurry D was not subjected to any treatments but was oven-dried and reslurried. Slurry E was subject only to the addition of alum in the amount of 0.2%, then was oven-dried and reslurried. Slurry F was subjected to a treatment of alum in the amount of 0.2% and a treatment of base in the amount of 0.33%, then was oven-dried and reslurried. Slurry G was subjected to a treatment of alum in the amount of 0.2%, a treatment of base in the amount of 0.33%, and a treatment of cationic polymer in the amount of 0.1%, then was oven-dried and reslurried. The results are shown in Table 4.

TABLE 4
Wettability tests using an Imhoff Cone

| | | | | | | Wettability |
|---|---|---|---|---|---|---|
| | | | | | | (Volume at the |
| | | | | After | After Oven- | bottom of |
| | | After | After | Cationic | Drying and | the Imhoff |
| Slurry | | Alum | NaOH | Polymer | Reslurrying | cone), mL |
| D | pH | X | X | X | 8.1 | 0.2 |
| | PCD | X | X | X | −215 | |
| E | pH | 4.4 | X | X | 6.9 | 1.6 |
| | PCD | −235 | X | X | −240 | |
| F | pH | 4.4 | 8.0 | X | 8.3 | 4.6 |
| | PCD | −235 | −380 | X | −300 | |
| G | pH | 4.4 | 8.0 | 7.9 | 7.9 | 28.0 |
| | PCD | −235 | −380 | +360 | +200 | |

The results in Table 4 show the increasing wettability of talc, indicated by the volume of talc particles that settled during the progressive additions of alum, base and cationic polymers. The cationicity and excellent wettability of the talc treated with alum, base and cationic polymer demonstrates treated talc as a desirable filler in papermaking. In addition, treated talc is a desirable filler for papermaking because: 1) the talc's excellent wettability will require less shear or energy in preparing a slurry for use in a papermaking process and 2) the talc's cationicity will improve its affinity to the anionic cellulosic fibers, resulting in improved paper properties such as greater strength and less porosity. The treated talc's affinity toward cellulosic fibers should also improve its retention in paper, which should further reduce the need for retention chemicals and other such additives.

### EXAMPLE 4

The effect of the treated talc on paper properties was then tested. Using the slurries from Example 2, various properties of paper were tested. The results are as follows:

TABLE 5
Properties of Paper Incorporating Treated Talc

| Paper Properties | Slurry A | Slurry B | Slurry C |
|---|---|---|---|
| Basis weight, gsm | 47.3 | 48.3 | 48.4 |
| Caliper, mm | 0.053 | 0.055 | 0.055 |
| Bulk, cc/g | 1.121 | 1.139 | 1.136 |
| Gloss, % | 22.6 | 22.3 | 23.2 |
| Brightness, % | 64.8 | 64.8 | 64.4 |
| Opacity, % | 91.8 | 92.1 | 91.9 |
| Tensile, BLM | 2380 | 2050 | 2390 |
| Porosity, sec/100 cc air | 116 | 116 | 132 |
| COF Static | 0.390 | 0.415 | 0.396 |
| COF Kinetic | 0.307 | 0.323 | 0.308 |
| Ash % | 28.2 | 28.1 | 27.5 |

The positive effects of the addition alum, base and cationic polymer treatments to talc are evident in the tensile and porosity results. Paper prepared from talc without alum and base treatments (Slurry B) had the lowest tensile strength while paper prepared from talc treated with alum, base, and cationic polymer treatments had the highest tensile strength and, also, the best porosity. The higher the porosity reading, the tighter or “closer” the paper structure. The superior tensile strength and porosity values are indicative of better paper consolidation, which reflects a better affinity of Slurry C to cellulosic fibers than either Slurry A or Slurry B.

### EXAMPLE 5

This example evaluates whether the reaction that causes the aluminum hydroxide to precipitate is irreversible. A good indication of whether the aluminum hydroxide precipitation is irreversible is to compare the amount of precipitate that forms when the pH of the solution is adjusted from 5 to 8 by adding a base with the amount of precipitate after the pH is subsequently readjusted from 8 to 5 by adding a dilute acid, in this case, dilute sulfuric acid. Alum precipitate, in solution, is evident at pHs of 7 and 8, and, depending on the amount of alum species present in solution, may or may not be noticeable at a pH of 6. In order to assess whether the reaction is reversible, five vials of treated talc particle and alum solution were prepared. The initial pH of each of the five vials was measured at 4. One vial was left at a pH of 4 as a control. In the second vial, the pH was adjusted to 5 by adding a dilute caustic soda solution to the vial. The same caustic soda solution was added to vials three, four and five to increase the pH of these vials to a pH of 6, 7, and 8 respectively. The presence of aluminum hydroxide precipitate was very noticeable at the pH of 7 and at the pH of 8. The contents of the fifth vial were shaken and poured into two additional vials, vials six and seven. The pH of vial six was adjusted to 7 while the pH of vial seven was adjusted to 6 by adding dilute sulfuric acid. The vials having a pH of 6 were then compared and the vials having a pH of 7 were also compared. The precipitate in each of the vials were comparable, showing that the precipitate stays despite further pH adjustments to the solution. It appears, from the results of this experiment, that the aluminum hydroxide precipitation onto the surface of the talc particles will stay anchored to the talc particles and be resistant to pH changes. Thus, it is clear that the change of the particle charge is an irreversible reaction.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

We claim:

1. A method for improving the wettability and increasing the affinity of talc to cellulosic fibers, comprising the steps of:
a) coating the surface of the talc with a metal hydroxide; and,
b) coating the surface of the talc with a cationic polymer.

2. The method according to claim 1, wherein the metal hydroxide is selected from the group consisting of aluminum hydroxide, chromium hydroxide, magnesium hydroxide, manganese hydroxide, and ferric hydroxide.

3. The method according to claim 1, wherein the cationic polymer is selected from the group consisting of cationic starch, polydadmacs, polyethyleneimines, and polyamines.

4. The method according to claim 1, wherein the cationic polymer is Alcofix.

5. The method according to claim 1, wherein the metal hydroxide is aluminum hydroxide.

6. The method according to claim 5, wherein the aluminum hydroxide is formed by reaction of an aluminum sulfate solution with a base.

7. The method according to claim 1, wherein a balance between the talc's natural hydrophobicity and the treated talc's hydrophilicity is achieved.

8. A talc material produced by the process of claim 1.

9. A method for modifying the surface of talc, comprising the steps of:
a) providing a talc slurry with at least about 20 weight percent solids;
b) adding a metal hydroxide to the talc slurry; and,
c) adjusting the pH of the slurry by addition of a base, whereby the talc is modified by an increase in the property selected from the group consisting of affinity to cellulosic fibers and wettability.

10. The method according to claim 9, wherein the metal hydroxide is selected from the group consisting of aluminum hydroxide, chromium hydroxide, magnesium hydroxide, manganese hydroxide, and ferric hydroxide.

11. The method according to claim 9, wherein the cationic polymer is selected from the group consisting of cationic starch, polydadmacs, polyethyleneimines, and polyamines.

12. The method according to claim 9, wherein the cationic polymer is Alcofix.

13. The method according to claim 9, wherein the metal hydroxide is aluminum hydroxide.

14. The method according to claim 13, wherein the aluminum hydroxide is formed by reaction of an aluminum sulfate solution with a base.

15. The method according to claim 9, wherein the base is potassium hydroxide.

16. The method according to claim 9, wherein the base is sodium hydroxide.

17. The method according to claim 9, wherein a balance between the talc's natural hydrophobicity and the treated talc's hydrophilicity is achieved.

18. A talc material produced by the process of claim 9.

19. A method for modifying the surface of talc to increase a property of talc selected from the group consisting of affinity to cellulosic fibers and wettability, comprising the steps of:
a) providing a talc slurry with at least about 10 weight percent solids;
b) adding a metal hydroxide to the talc slurry;
c) adjusting the pH of the slurry through addition of a base; and,
d) adding a cationic polymer to the slurry.

20. The method according to claim 19, wherein the metal hydroxide is selected from the group consisting of aluminum hydroxide, chromium hydroxide, magnesium hydroxide, manganese hydroxides and ferric hydroxide.

21. The method according to claim 19, wherein the cationic polymer is selected from the group consisting of cationic starch, polydadmacs, polyethyleneimines, and polyamines.

22. The method according to claim 19, wherein the cationic polymer is Alcofix.

23. The method according to claim 19, wherein the metal hydroxide is aluminum hydroxide.

24. The method according to claim 23, wherein the aluminum hydroxide is formed by reaction of an aluminum sulfate solution with a base.

25. The method according to claim 19, wherein the base is potassium hydroxide.

26. The method according to claim 19, wherein the base is sodium hydroxide.

27. The method according to claim 19, wherein a balance between the talc's natural hydrophobicity and the treated talc's hydroplilicity is achieved.

28. A talc material produced by the process of claim 19.

29. A method for modifying the surface of talc, comprising the steps of:
a) creating a talc slurry with at least about 20 weight percent solids;
b) adding a metal hydroxide to the talc slurry;
c) adjusting the pH of the slurry through the addition of a base;
d) adding a cationic polymer to the slurry wherein the surface charge of the talc is reversed.

30. The method according to claim 29, wherein the metal hydroxide is selected from the group consisting of aluminum hydroxide, chromium hydroxide, magnesium hydroxide, manganese hydroxide, and ferric hydroxide.

31. The method according to claim 29, wherein the cationic polymer is selected from the group consisting of cationic starch, polydadmacs, polyethyleneimines, and polyamines.

32. The method according to claim 29, wherein the cationic polymer is Alcofix.

33. The method according to claim 29, wherein the metal hydroxide is aluminum hydroxide.

34. The method according to claim 33, wherein the aluminum hydroxide is formed by reaction of an aluminum sulfate solution with a base.

35. The method according to claim 29, wherein the base is potassium hydroxide.

36. The method according to claim 29, wherein a balance between the talc's natural hydrophobicity and the treated talc's hydrophilicity is achieved.

37. A talc material produced by the process of claim 29.

38. A paper product having a modified talc filler wherein the modified talc filler is coated with a metal hydroxide.

39. The paper product according to claim 28, wherein the modified talc filler is further coated with a cationic polymer.
